(19) United States
(12) Patent Application Publication
(10) Pub. No.: US 2017/0050867 A1
(43) Pub. Date: Feb. 23, 2017

(54) HYDROGEN WATER GENERATOR

(71) Applicants: KOREA INSTITUTE OF SCIENCE DEVELOPMENT (KISD), Daejeon (KR); SION TECH CO., LTD., Daejeon (KR)

(72) Inventors: Kyung Seok KANG, Daejeon (KR); Hyun Jong PARK, Seoul (KR); HO IL LEE, Daejeon (KR); Dong Pyo LIM, Daejeon (KR)

(73) Assignees: KOREA INSTITUTE OF SCIENCE DEVELOPMENT (KISD), Daejeon (KR); SION TECH CO., LTD., Daejeon (KR)

(21) Appl. No.: 15/061,186

(22) Filed: Mar. 4, 2016

(30) Foreign Application Priority Data
Aug. 21, 2015 (KR) 10-2015-0118052

(51) Int. Cl. C02F 1/467; C25B 1/10

(52) U.S. Cl. CPC C02F 1/4676; C25B 1/10; C02F 2201/46115

(57) ABSTRACT

Disclosed is a hydrogen water generator that includes a hydrogen water generating module having a gas discharge unit at an upper portion thereof and an electrode module at a lower portion thereof and a batch type body, and also includes an upper cap that may be coupled to or separated from the body and is connected to the gas discharge unit and a power supply unit to generate hydrogen water that does not contain substances such as chlorine and ozone.

### BACKGROUND OF THE INVENTION

Field of the Invention

The present invention relates to a hydrogen water generator, and more particularly to a hydrogen water generator that includes a hydrogen water generating module having a gas discharge unit at an upper portion thereof and an electrode module at a lower portion thereof and a batch type body, and also includes an upper cap that may be coupled to or separated from the body and is connected to the gas discharge unit and a power supply unit to generate hydrogen water that does not contain substances such as chlorine and ozone.

Description of the Related Art

Water in which hydrogen is dissolved is called hydrogen water, and generally, water that contains 0.2 ppm to 1.6 ppm of hydrogen at room temperature is called hydrogen water. A portable hydrogen water generator mainly used currently generates water containing hydrogen, that is, hydrogen water by electrolyzing water using a platinum electrode or an electrode coated with a platinum group metal in a non-diaphragm electrolytic cell and generating hydrogen in a negative electrode.

However, generally used water such as tab water or underground water contains a small amount of salt (NaCl) in the form of ions (Na+and Cl−) in addition to water, and if the salt contained water is electrolyzed, chlorine ions (Cl−) are oxidized in a positive electrode to generate chlorine (C12(g)), materials, such as sodium hypochlorite (NaOCl), which are chlorine disinfectant substances used to disinfect tab water are also generated. A reaction in which sodium hypochlorite (NaOCl) is generated is as follows.

Anode Reaction

2Cl−→C12+2e−

2HO→4H++O2+4e

Cathode Reaction

2H2O+2e→2OH−+H2

Na++OH−→NaOH

Whole Reaction

NaOH+C12→NaOCl+NaCl+H2O

When hydrogen water is generated by electrolyzing water that does not contain salt to prevent generation of sodium hypochlorite (NaOCl), ozone (O3) is generated in a positive electrode.

A water electrolytic reaction is as follows.

Anode Reaction

2H2O→4H++O2+4e

Cathode Reaction

2H2O+2e→2OH−+H2

Whole Reaction

2H2O→2H2+O2

Meanwhile, the theoretical voltage for water electrolysis is 1.23 V, but a voltage (an overvoltage) higher than the theoretical voltage is necessary to actually electrolyze water due to various conditions such as a distance between electrode and an electrolyte.

2H2O→4H++O2+4e (E0=1.23 V)

Ozone is generated when an overvoltage is applied to a platinum electrode, and the reaction is as follows.

3H2O→6H++O3+6e (E0=1.51 V)

As a result, there is a problem that water containing ozone in addition to hydrogen is generated.

In generating hydrogen water, a technology including an active carbon filter that adsorbs and removes chlorine and volatile substances to solve the above problems of generating sodium hypochlorite (NaOCl) and ozone has been developed, which is suggested in Korean Patent Application Publication No. 2013-0073831 entitled ‘Hydrogen Water Generator’.

However, the conventional technology should apply a separate structure to mount a filter, and filters should be periodically exchanged to be used. Further, germs are propagated in the filter, which causes a sanitary problem.

Furthermore, because hydrogen, which is a non-polar gas, is not easily solved in water, a unit for improving dissolved hydrogen is needed.

### PATENT LITERATURE

Patent Literature 1: Korean Patent Application Publication No. 2013-0073831 (Title of Invention: Hydrogen Water Generator)

### SUMMARY OF THE INVENTION

The present invention has been made in an effort to solve the above-mentioned problems, and provides a hydrogen water generator that, in generating hydrogen water, generates hydrogen water through electrolysis, does not require a separate filter because the generated hydrogen water does not contain a chlorine disinfectant substance and ozone, and can generate hydrogen water having a high level of dissolved hydrogen.

According to an aspect of the invention to achieve the object described above, there is provided a hydrogen water generator that manufactures hydrogen water by dissolving hydrogen generated through electrolysis of water in raw water, the hydrogen water generator including: a body 100 having a box shape, of which an upper side is opened; an upper cap 200 coupled to or separated from an upper portion of the body 100; a power supply unit 300 provided at a lower portion of the body 100; and a hydrogen water generating module 400 comprising a body 430 having a box shape, of which an upper side and a lower side are opened, a gas discharge unit 410 provided at an upper end of the body 430 to be opened and closed, and an electrode module 420 provided at a lower end of the body 430, in the interior of the body 100, to electrolyze water, wherein when the upper cap 200 is coupled to the body 100, the gas discharge unit 410 is opened such that the interior and the exterior of the hydrogen water generating module 400 are opened, and when the upper cap 200 is separated from the body 100, the gas discharge unit 410 is closed, so that the interior of the hydrogen water generating module 400 is closed from the exterior of the hydrogen water generating module 400.

Preferably, the gas discharge unit 410 includes: a bar-shaped stick 411 provided in the interior of the body, and a spring 412, one side of which is fixed to the stick 411 and an opposite side of which is fixed to the interior of the body 430 to generate a resilient force that pushes the stick 411 upwards, and wherein a pusher 220 is provided at a lower portion of the upper cap 200, and when the upper cap 200 is coupled to the body 100, the pusher 220 makes contact with the stick 411 to push the stick 411 downwards so as to open the hydrogen water generating module 400.

Preferably, the electrode module 420 includes: a positive electrode 421 provided on an inner side of the hydrogen water generating module 400, a negative electrode 422 provided on an outer side of the hydrogen water generating module 400, and a separator 423 provided between the positive electrode 421 and the negative electrode 422.

Preferably, the positive electrode 421 and the negative electrode 422 of the hydrogen water generating module 400 have a peripheral surface of a mesh shape and cylindrical or polygonal column shapes.

Preferably, the positive electrode 421 and the negative electrode 422 of the hydrogen water generating module 400 have a peripheral surface broken vertically.

Preferably, the separator 423 employs at least any one of a neutral membrane, a solid polymeric electrolyte membrane, and a porous sintered metal support.

Preferably, the solid polymeric electrolyte membrane has a positive ion exchanger or a negative ion exchanger and the porous sintered metal support is obtained by coating an ion selective solid polymeric solution having a positive ion exchanger or an ion selective solid polymeric solution having a negative ion exchanger on the porous sintered metal support.

Preferably, the upper cap 200 has a pressure adjusting unit 210 supported by a resilient force of a spring and enclosing an interior of the body 100 and the pressure adjusting unit 210 is opened when the internal pressure of the body 100 is above the resilient force of the spring.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a hydrogen water generator according to the present invention;

FIG. 2 is a sectional view of the hydrogen water generator according to the present invention;

FIG. 3 is a perspective view of an electrode module of the hydrogen water generator according to the present invention;

FIG. 4 is a sectional view of the electrode module of the hydrogen water generator according to the present invention;

FIG. 5 is a sectional view of the hydrogen water generator when an upper cap is separated according to the present invention;

FIG. 6 is a sectional view of the hydrogen water generator when the upper cap is coupled according to the present invention; and

FIG. 7 is a sectional view of a pressure adjusting unit when an internal pressure of the hydrogen water generator is discharged according to the present invention.

### DETAILED DESCRIPTION OF THE PREFERRED EMBODIMENT

Hereinafter, a preferred embodiment of the invention will be described in detail with reference to the accompanying drawings.

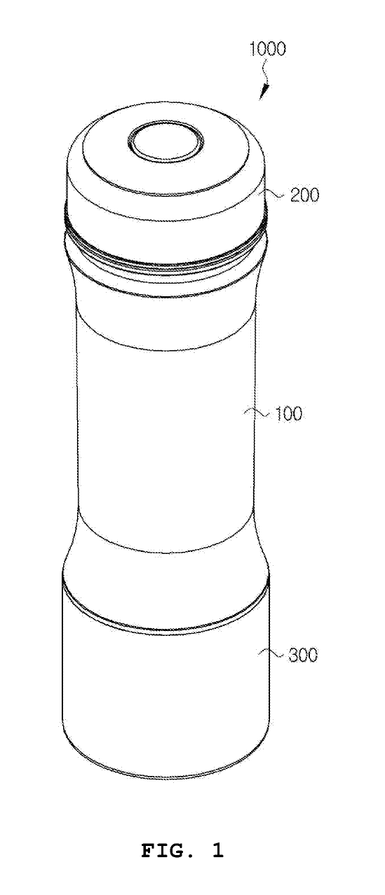

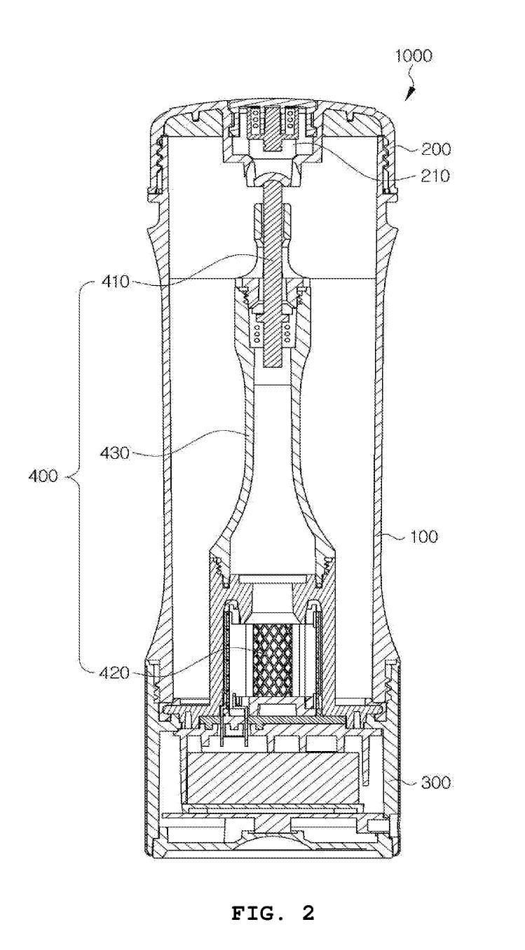

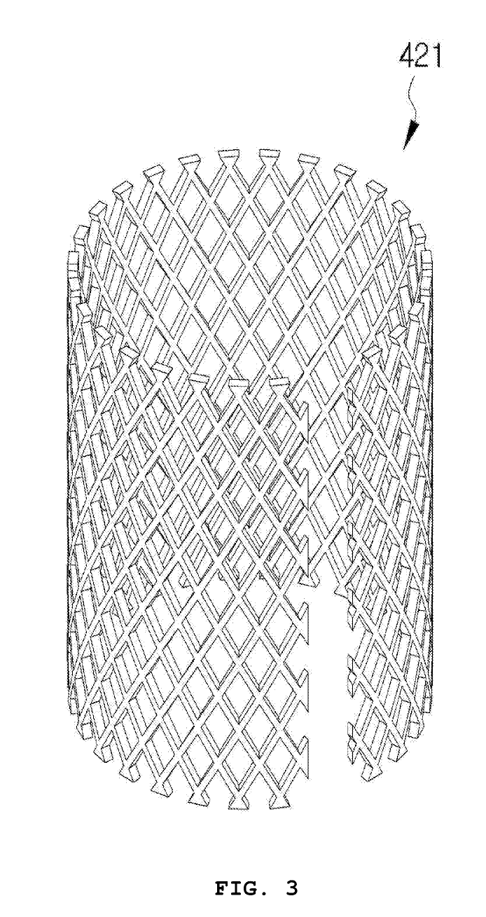

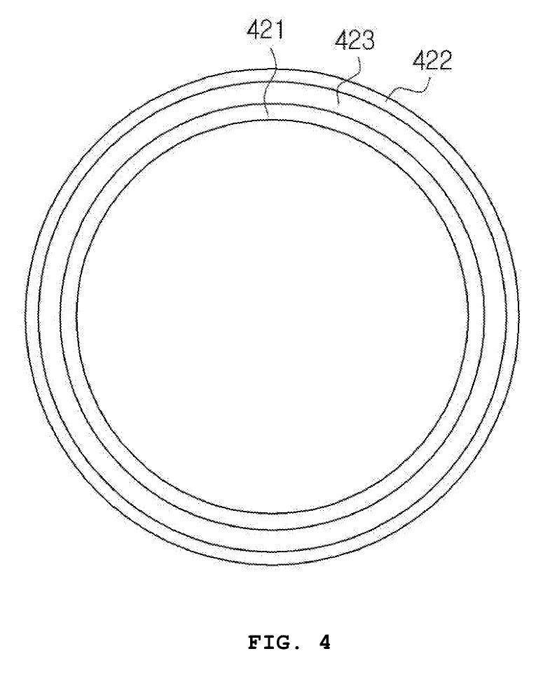

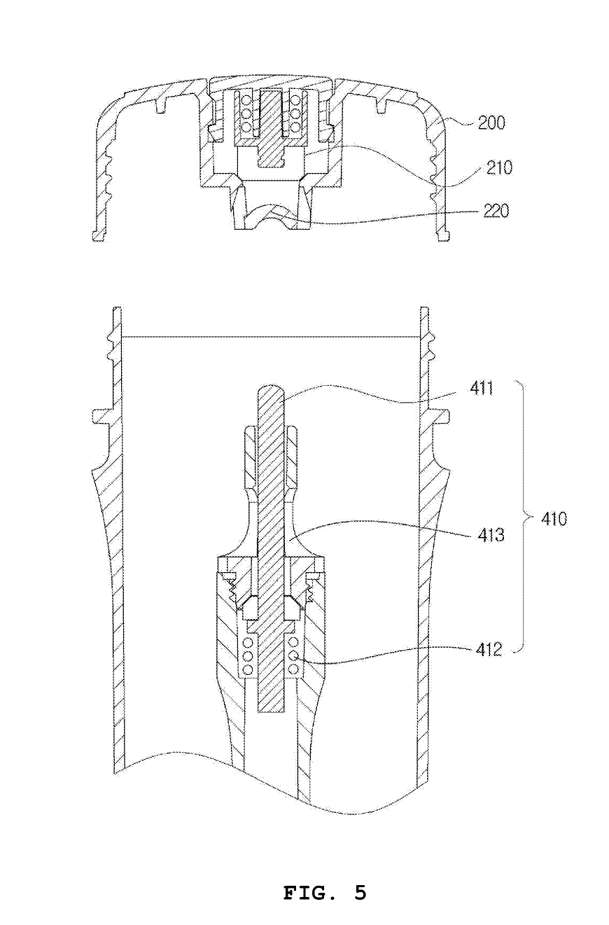

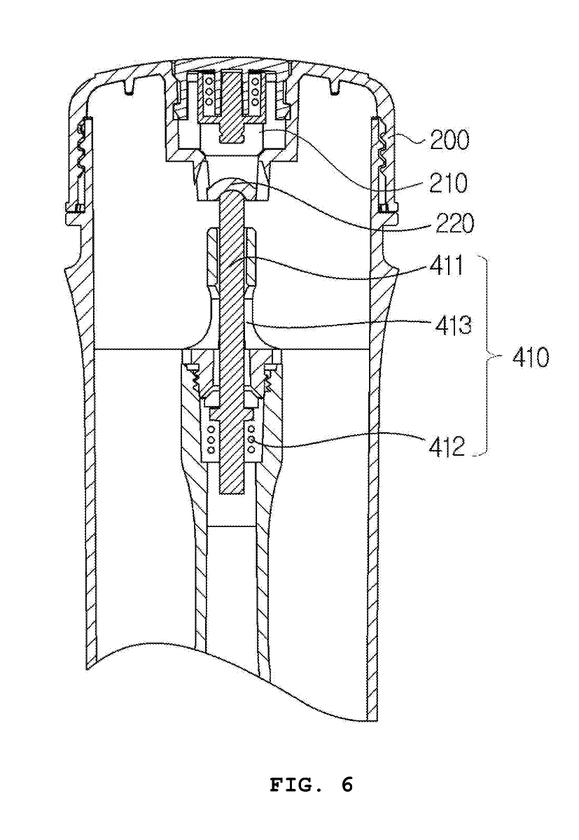

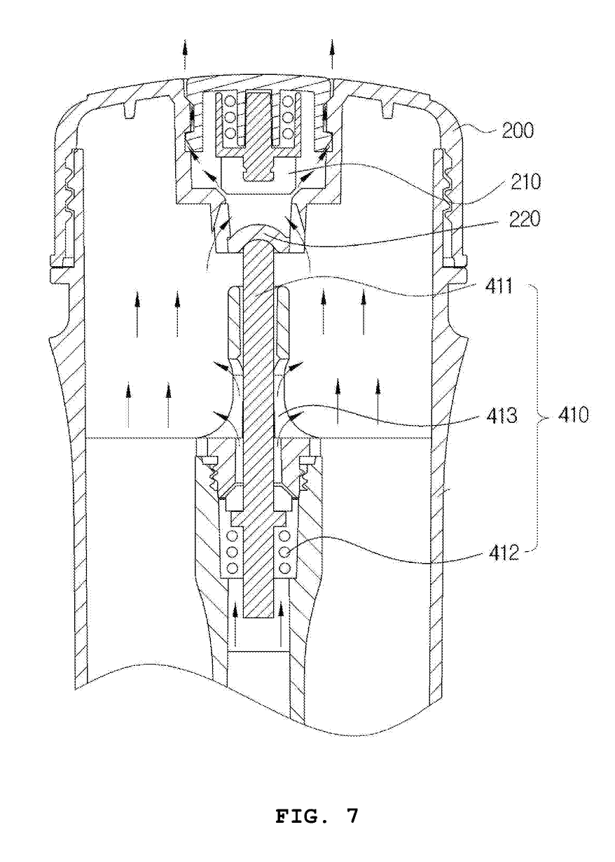

FIG. 1 is a perspective view of a hydrogen water generator 1000 according to the present invention, FIG. 2 is a sectional view of the hydrogen water generator 1000 according to the present invention, FIG. 3 is a perspective view of an electrode module 420 of the hydrogen water generator 1000 according to the present invention, FIG. 4 is a sectional view of the electrode module 420 of the hydrogen water generator 1000 according to the present invention, FIG. 5 is a sectional view of the hydrogen water generator 1000 when an upper cap 200 is separated according to the present invention, FIG. 6 is a sectional view of the hydrogen water generator 1000 when the upper cap 200 is coupled according to the present invention, and FIG. 7 is a sectional view of a pressure adjusting unit 210 when an internal pressure of the hydrogen water generator 1000 is discharged according to the present invention.

Firstly, FIGS. 1 and 2 are the representative drawings of the present invention, and illustrate a perspective view and a sectional view of the hydrogen water generator 1000 according to the present invention. Referring to FIGS. 1 and 2, the hydrogen water generating apparatus 1000 according to the present invention includes a hydrogen water generating module 400 having a gas discharge unit 410 at an upper portion thereof and having an electrode module 420 at a lower portion thereof, a body 100 that accommodates the hydrogen water generating module 400 in the interior thereof, an upper cap 200 coupled to or separated from an upper portion of the body 100, and a power supply unit 300 coupled to a lower portion of the body 100.

In a more detailed description of the configurations of the hydrogen water generator 1000 according to the present invention, the body 100 has a box shape, of which the upper side is opened, to accommodate the hydrogen water generating module 400 in the interior thereof and may contain a predetermined amount of water in the interior thereof to generate hydrogen water in a batch type.

The upper cap 200 is coupled to or separated from an upper portion of the body 100, and has a pressure adjusting unit 210 inside the upper cap 200.

Then, it is preferable that a screw thread is formed on an inner peripheral surface of the upper cap 200 and a screw thread corresponding to the screw thread of the upper cap 200 is formed on an outer peripheral surface of an upper portion of the body 100 such that the upper cap 200 and the body 100 are coupled to each other through screw coupling by rotation thereof, but the coupling method is not limited thereto as long as the liquid and the gas in the interior of the body 100 is not leaked to the outside when the upper cap 200 is coupled.

Meanwhile, the pressure adjusting unit 210 functions as a safety valve that prevents the internal pressure of the body 100 from being increased to a predetermined pressure or higher, by discharging the internal pressure of the body 100 to the outside if it is increased to the predetermined pressure or higher.

The power supply 300 is coupled to a lower portion of the body 100, and a control unit is provided together with the power supply unit 300 to supply electric power for allowing the hydrogen water generating module 400 to electrolyze water.

The hydrogen water generating module 400 includes a body 430 having a box shape, of which the upper and lower sides are opened, an electrode module 420 provided at a lower portion of the body 430 to generate hydrogen and oxygen, an upper cap 200 provided at an upper portion of the body 430, and a gas discharge unit 410 opened and closed through coupling and separation of the body 100.

The interior of the hydrogen water generating module 400 and the interior of the body 100 are opened when the upper cap 200 is coupled to the body 100 and is closed when the upper cap 200 is separated from the body 100 by the gas discharge unit 410. The structure of the gas discharge unit 410 has a form that is in the reverse direction to the structure of a check valve, and the gas discharge unit 410 is closed by a resilient force of a spring if the body 100 and the upper cap 200 are separated from each other and is opened if the body 100 and the upper cap 200 is coupled to each other.

Due to the gas discharge unit 410 having the above structure, the gas discharge unit 410 is opened so that the water outside the hydrogen water generating module 400 is supplied into the interior of the hydrogen water generating module 400 if water is filled up to a predetermined height in a space between the outer surface of the hydrogen water generating module 400 and the inner surface of the body 100 and the body 100 and the upper cap 200 are coupled to each other, and the gas discharge unit 410 is closed if the upper cap 200 is separated so that the water in the interior of the hydrogen water generating module 400 is not withdrawn to the outside when the body 100 is inclined for drinking.

If water is filled in the body 100 and the upper cap 200 is coupled, a through-hole of the gas discharge unit 410 is opened so that the water is introduced into the interior of the hydrogen water generating module 400, and then if an electrolytic reaction is initiated, oxygen is generated in the positive electrode and hydrogen is generated in the negative electrode.

The oxygen and hydrogen gases generated through the electrolytic reaction are discharged to the body 100 through the gas discharge unit 410 and makes contact with the pressure adjusting unit 210 of the upper cap 200.

The pressure adjusting unit 210 of the upper cap 200 is configured to maximally increase the dissolved hydrogen, and is configured to maximally dissolving hydrogen in water by increasing the pressure of hydrogen in the interior of the body 100 according to Henry's law telling that the amount of a gas that may be dissolved in the same amount of a liquid at the same temperature is proportional to the partial pressure of the gas.

Then, the pressure adjusting unit 210 is provided inside the upper cap 200 to open and close the interior and exterior of the body 100, and adjusts the opening and closing of the body 100 as it is spaced upwards and downwards due to a resilient operation of the spring.

The pressure adjusting unit 210 increases the internal pressure of the body 100 by restraining discharge of hydrogen generated due to an electrolytic reaction to the outside, and accordingly, maximally dissolves hydrogen in water. Then, when the internal pressure is excessively increased, the inner gas is instantaneously discharged to the outside so that damage to a container due to an overpressure can be prevented in advance.

The sizes of the elements of the hydrogen water generator 1000 having the above structure are not limited, and the hydrogen water generator 1000 may be used for various purposes according to the sizes of the elements. The body 100 may have a small size such that a battery is included in the power supply unit so that the hydrogen water generator 100 may be used for portable purposes, and may be applied for various forms such as a portable form and a stand form and various modifications may be made according to the necessity of the user.

Next, FIGS. 3 and 4 illustrate a perspective view and a sectional view of the electrode module 420 of the hydrogen water generator 1000 according to the present invention. Referring to FIGS. 3 and 4, the electrode module 420 of the hydrogen water generating module 400 has a diaphragm type electrolytic cell structure including a positive electrode 421, a separator 423, and a negative electrode 422. The positive electrode 421 and the negative electrode 422 have mesh shapes that have through-holes and have cylindrical or polygonal column shapes, of which sides are vertically broken.

The positive electrode and the negative electrode of the electrode module 420 are dimensionally stable electrodes on which a platinum electrode or a platinum group metal is coated after being sintered, and have through-holes so that the hydrogen and oxygen generated during the electrolytic reaction smoothly flow through the through-holes.

Because a maximum electrode area of the electrode module 420 can be secured while the volume thereof is minimized if the electrode module 420 has a cylindrical or polygonal column shape, a large amount of hydrogen can be generated as compared with a hydrogen water generator to which a plate type electrode having the same volume is applied so that the concentration of the dissolved hydrogen can be increased.

The electrode module 420 has a positive electrode 421 on the inner side thereof and has a negative electrode 422 on the outer side thereof, and the separator 423 is provided between the positive electrode 421 and the negative electrode 422 such that the positive electrode 421 is situated inside the hydrogen water generating module 400 and the negative electrode 422 is situated outside the hydrogen water generating module 400.

Then, oxygen is generated inside the electrode module 420 due to the positive electrode 421 so that oxygen is dissolved in the water in the interior of the hydrogen water generating module 400, and hydrogen is generated outside the electrode module 420 due to the negative electrode 422 so that hydrogen is dissolved in the water outside the hydrogen water generating module 400.

Due to the structure, the water electrolyzed in the interior of the hydrogen water generator 1000 is divided into the water in which hydrogen is dissolved between the body 100 and the hydrogen water generating module 400 and the water in which oxygen and a chlorine disinfectant substance are dissolved in the interior of the hydrogen water generating module 400. Then, if the upper cap 200 is separated, the water in which the oxygen and the chlorine disinfectant substance are dissolved is enclosed in the interior of the hydrogen water generating module 400 while the gas discharge unit 410 is closed so that only hydrogen water in the interior of the body 100 in which hydrogen is dissolved can be drunk. If all the hydrogen water is drunk, the gas discharge unit 410 is directly opened by the user so that the water in which the oxygen and the chlorine disinfectant substance are dissolved is discharged and discarded.

Through the method, pure hydrogen water without foreign substances such as oxygen and a chlorine disinfectant substance can be generated for drinking, without employing various filters that adsorbs oxygen and a chlorine substance in the interior of the body 100.

Meanwhile, it is preferable that the separator 423 employ any one of a neutral membrane, a solid polymeric electrolyte membrane that may selectively pass any one of a positive ion and a negative ion, and a porous sintered metal support separator.

Among the types of the separator 423, the porous sintered metal support is obtained by coating an ion selective solid polymeric solution having a positive ion exchanger or an ion selective solid polymeric solution having a negative ion exchanger on the porous sintered metal support such as titanium (Ti) or stainless steel (STS316), and it is preferable that the cell size of the porous sintered metal support is 10 μm to 3000 μm, the thickness thereof is 0.5 mm to 4.5 mm, and the porosity thereof is 80 to 95%.

Further, one surface of the porous sintered metal support on which the ion selective solid polymeric solution is coated moves only hydrogen ions to the positive electrode to generate hydrogen in the negative electrode 422, and a metal surface is exposed from an opposite surface of the porous sintered metal support to make contact with the negative electrode 422 so that the surface area of the negative electrode 422 is increased. Then, when dissolved solid materials such as calcium and magnesium are present in the raw water that is supplied to obtain hydrogen water, calcium hydroxide or magnesium hydroxide may be deposited on the negative electrode 422 so that electrolysis efficiency may be abruptly decreased because the surface of the negative electrode 422 is increased, but the time period for which calcium hydroxide or magnesium hydroxide is deposited on the negative electrode 422 is increased to prevent abrupt lowering of the electrolysis efficiency because the porous sintered metal net from which a metal surface in contact with the negative electrode 422 increases the surface area of the negative electrode 422.

Meanwhile, the lateral surface of the cylindrical or polygonal column shape is partially broken vertically because an effect such as a plate spring can be obtained by using the resiliencies of the positive electrode 421 and the negative electrode 422. That is, when the electrode module 420 is assembled, if the positive electrode 421, the separator 423, and the negative electrode 422 are coupled to each other and are inserted into and fixed to an electrode module fixing case having an inner diameter smaller than that of the electrode module 420 by applying an external force to the broken section, the positive electrode 421 is adhered to the separator 423 by the resiliency of the electrode module 420 while applying a pressure to the separator 423 and the negative electrode 422 is also adhered to the separator 423 while applying a pressure to the separator 423, so that a separate unit for adhering the positive electrode 421 and the negative electrode 422 is not necessary.

Next, FIG. 5 is a sectional view illustrating a case in which the upper cap 200 of the hydrogen water generator 1000 according to the present invention is not coupled but separated. Referring to FIG. 5, if the upper cap 200 is not coupled to the body 100, the gas discharge unit 410 is closed so that the interior of the hydrogen water generating module 400 is enclosed. Then, if water is introduced into the interior of the body 100, the water is filled in a space between the hydrogen water generating module 400 and the body 100.

In a more detailed description of the gas discharge unit 410, the gas discharge unit 410 includes a bar-shaped stick 411 having a length coupled to an upper inner peripheral surface of the body 430 to be movable upwards and downwards, a spring 412 fixed to a lower portion of the stick 411 to generate an upward/downward resilient force, and a through-hole 413 horizontally formed at an upper portion of the body 430.

Then, a stopper step protruding from the inner peripheral surface to the center of the body 430 is formed on the inner peripheral surface of the body 430 at a location spaced from the upper side of the body 430 towards the lower side of the body 430 by a predetermined distance. It is preferable that the stick 411 is inserted into a hole formed by the stopper step to move upwards and downwards so as to open and close the hole on the stopper step, one side of the spring 412 is fixed to the stopper step and an opposite side of the spring 412 is fixed to the stick 411 to generates an upward resilient force in the stick 411, and the through-hole 413 of the body 430 is formed on the body 430 at a location higher than the horizontal line of the stopper step.

Meanwhile, a pusher 220 is provided at a lower portion of the upper cap 200. The pusher 220 is spaced apart from the center of a lower portion of the upper cap 200 towards the lower side by a predetermined interval. When the upper cap 200 is coupled to the body 100, a lower end surface of the pusher 220 makes contact with an upper end surface of the stick 411, and when the upper cap 200 is completely coupled, the pusher 220 pushes the stick 411 towards the lower side to press the stick 411. Then, the hydrogen water generating module 400 is opened as the stick 411 is spaced apart so that the water in the interior of the body 100 is partially introduced into the interior of the hydrogen water generating module 400.

Next, FIG. 6 is a sectional view illustrating a case in which the upper cap 200 of the hydrogen water generator 1000 according to the present invention is coupled. Referring to FIG. 6, if the upper cap 200 is coupled to the body 100, the gas discharge unit 410 is opened so that the interior of the hydrogen water generating module 400 is opened. Then, the water introduced into the interior of the body is filled in the interior of the hydrogen water generating module 400.

Then, because the water is introduced into the interior of the hydrogen water generating module 400 through a through-hole 413 of the gas discharge unit 410, only the water in the interior of the body 100 that is situated above the through-hole is introduced into the interior of the hydrogen water generating module 400.

Finally, FIG. 7 is a view illustrating a sectional view of the case in which the internal pressure of the hydrogen water generator 1000 according to the present invention is discharged to the outside. Referring to FIG. 7, when the internal pressure of the body 100 is a predetermined pressure or lower, the pressure adjusting unit 210 encloses the interior of the body 100 so that the generated gas is not discharged to the outside, but when the internal pressure of the body 100 rises up to a predetermined pressure or higher, the spring supporting the pressure adjusting unit 210 is spaced apart upwards so that the pressure adjusting unit 210 is opened so that the gas in the interior of the body 100 is discharged to the outside to adjust the pressure in the interior of the body 100.

The hydrogen water generator having the above features does not generate harmful substances such as sodium hypochlorite and ozone when hydrogen water is generated, and accordingly, can solve the problems such as propagation of germs generated due to the mounted filter because it does not require a separate filter, and can reduce maintenance costs generated when the filters are periodically exchanged.

Also, the hydrogen water generator according to the present invention is provided with the pressure adjusting unit for adjusting the internal pressure thereof, so that the internal pressure of the hydrogen water generator can be adjusted and the dissolved hydrogen can be maximally increased.

Moreover, the electrode module of the hydrogen water generator according to the present invention has the cylindrical or the polygonal column shape, so that the volume thereof can be minimized in comparison with the electrode module of the plate type.

Furthermore, since the maximum electrode area of the electrode module can be secured as compared with the hydrogen water generator, to which the plate type electrode having the same volume is applied, a large amount of hydrogen can be generated in comparison with the electrode module of the plate type.

While the present invention has been described with respect to the specific embodiments, it will be apparent to those skilled in the art that various changes and modifications may be made without departing from the spirit and scope of the invention as defined in the following claims.

What is claimed is:

1. A hydrogen water generator that manufactures hydrogen water by dissolving hydrogen generated through electrolysis of water in raw water, the hydrogen water generator comprising:
a body (100) having a box shape, of which an upper side is opened;
an upper cap (200) coupled to or separated from an upper portion of the body (100);
a power supply unit (300) provided at a lower portion of the body (100); and
a hydrogen water generating module (400) comprising a body (430) having a box shape, of which an upper side and a lower side are opened, a gas discharge unit (410) provided at an upper end of the body (430) to be opened and closed, and an electrode module (420) provided at a lower end of the body (430), in the interior of the body (100), to electrolyze water,
wherein when the upper cap (200) is coupled to the body (100), the gas discharge unit (410) is opened such that the interior and the exterior of the hydrogen water generating module (400) are opened, and when the upper cap (200) is separated from the body (100), the gas discharge unit (410) is closed, so that the interior of the hydrogen water generating module (400) is closed from the exterior of the hydrogen water generating module (400).

2. The hydrogen water generator as claimed in claim 1, wherein the gas discharge unit (410) comprises: a bar-shaped stick (411) provided in the interior of the body, and a spring (412), one side of which is fixed to the stick (411) and an opposite side of which is fixed to the interior of the body (430) to generate a resilient force that pushes the stick (411) upwards, and wherein a pusher (220) is provided at a lower portion of the upper cap (200), and when the upper cap (200) is coupled to the body (100), the pusher (220) makes contact with the stick (411) to push the stick (411) downwards so as to open the hydrogen water generating module (400).

3. The hydrogen water generator as claimed in claim 1, wherein the electrode module (420) comprises: a positive electrode (421) provided on an inner side of the hydrogen water generating module (400), a negative electrode (422) provided on an outer side of the hydrogen water generating module (400), and a separator (423) provided between the positive electrode (421) and the negative electrode (422).

4. The hydrogen water generator as claimed in claim 3, wherein the positive electrode (421) and the negative electrode (422) of the hydrogen water generating module (400) have a peripheral surface of a mesh shape and cylindrical or polygonal column shapes.

5. The hydrogen water generator as claimed in claim 3, wherein the positive electrode (421) and the negative electrode (422) of the hydrogen water generating module (400) have a peripheral surface broken vertically.

6. The hydrogen water generator as claimed in claim 3, wherein the separator (423) employs at least any one of a neutral membrane, a solid polymeric electrolyte membrane, and a porous sintered metal support.

7. The hydrogen water generator as claimed in claim 6, wherein the solid polymeric electrolyte membrane has a positive ion exchanger or a negative ion exchanger and the porous sintered metal support is obtained by coating an ion selective solid polymeric solution having a positive ion exchanger or an ion selective solid polymeric solution having a negative ion exchanger on the porous sintered metal support.

8. The hydrogen water generator as claimed in claim 1, wherein the upper cap (200) has a pressure adjusting unit (210) supported by a resilient force of a spring and enclosing an interior of the body (100) and the pressure adjusting unit (210) is opened when the internal pressure of the body (100) is above the resilient force of the spring.
